(19) United States
(12) Patent Application Publication
(10) Pub. No.: US 2016/0045942 A1
(43) Pub. Date: Feb. 18, 2016

(54) METHOD AND APPARATUS FOR REMOVING RESIDUE LAYER

(71) Applicant: TOKYO ELECTRON LIMITED, Tokyo (JP)

(72) Inventors: Kenichi HARA, Nirasaki City (JP); Naoshige FUSHIMI, Nirasaki City (JP)

(21) Appl. No.: 14/828,080

(22) Filed: Aug. 17, 2015

(30) Foreign Application Priority Data
Aug. 18, 2014 (JP) 2014-165946

(51) Int. Cl. B08B 6/00

(52) U.S. Cl. CPC B08B 6/00

(57) ABSTRACT

A method of removing a residue layer formed on a side surface of each of a plurality of convex-shaped structure which stands together on a surface of a substrate or a side surface of a concave-shaped structure formed on the substrate, includes disposing an electrostatic lens between the substrate and a charged particle irradiation mechanism which linearly irradiates a beam of charged particles onto the substrate. The electrostatic lens diverges the beam of charged particles.

### CROSS-REFERENCE TO RELATED APPLICATION

This application claims the benefit of Japanese Patent Application No. 2014-165946, filed on Aug. 18, 2014, in the Japan Patent Office, the disclosure of which is incorporated herein in its entirety by reference.

### TECHNICAL FIELD

The present disclosure relates to a method and apparatus for removing a residue layer.

### BACKGROUND

In recent years, a magneto-resistive random access memory (MRAM) has been developed as the next generation nonvolatile memory in place of DRAM and SRAM. The MRAM has a magnetic tunnel junction (MTJ) element instead of a capacitor, and stores information using a magnetization state.

The MTJ element includes an insulating film, e.g., an MgO film and two ferromagnetic films (for example, CoFeB films) facing each other with the MgO film interposed therebetween and the MRAM includes the MTJ element and a noble metal film such as a Ta film or a Ru film.

In a stack structure as shown in FIG. 13A, which includes a MgO film 100, two opposing CoFeB films 101 and 102 with the MgO film 100 interposed therebetween, a Ta film 103 and a Ru film 104, the MRAM is fabricated by forming a pillar structure 107 as shown in FIG. 13B, which is obtained by etching the films using an insulating hard mask 105 or a metallic hard mask 106.

However, when the pillar structure 107 is obtained by etching, a damage layer (not shown) which lost its crystalline orientation is formed on the side surface of the pillar structure 107 due to the ion implantation. In addition, if sputtering in etching is weak, metal particles scattered from an etched surface are adhered to form a residue layer 108 on the side of the pillar structure 107 (see FIG. 13C).

Since the residue layer 108 or the damage layer inhibit the insulating function of the MgO film 100 or the magnetic properties of the CoFeB films 101 and 102, the MRAM having the pillar structure 107 may not show desired performance. Therefore, there is a need to remove the residue layer 108 and the damage layer from the pillar structure 107.

On the other hand, since noble metal such as Ta or Ru which is an etching-resistive material is included in the residue layer 108, it is effective to remove the residue layer 108 by irradiating oxygen GCIB (Gas Cluster Ion Beam). The GCIB has a small beam diameter and high directionality. For this reason, in order to irradiate the oxygen GCIB onto the residue layer 108 formed on the side of the pillar structure 107, there has been proposed a technology for irradiating the oxygen GCIB on the surface of the wafer as a substrate having on its surface a plurality of pillar structures 107 while tilting the wafer.

However, when the wafer is tilted and the surface of the wafer is bombarded with the oxygen GCIB in one direction, the oxygen GCIB 111 is irradiated onto only a portion of the side surface of each pillar structure 107, as shown in FIG. 14. Accordingly, in order to completely remove the residue layer 108 from the entire side surface of each pillar structure 107, there is a need to repeat changing the inclined angle of the wafer W and irradiating the oxygen GCIB onto the side surface of each pillar structure 107, thereby bombarding the oxygen GCIB 111 on the entire surface of the wafer W. That is, there is a problem of poor efficiency in removing the residue layer 108 formed on the side of the pillar structure 107.

### SUMMARY

Some embodiments of the present disclosure provide a method and apparatus for removing a residue layer, which is capable of increasing efficiency for removing a residue layer formed on the side surface of a convex structure or a side surface of a concave-shaped structure.

According to one embodiment of the present disclosure, there is provided a method of removing a residue layer formed on a side surface of each of a plurality of convex-shaped structure which stands together on a surface of a substrate or a side surface of a concave-shaped structure formed on the substrate, including: disposing an electrostatic lens between the substrate and a charged particle irradiation mechanism which linearly irradiates a beam of charged particles onto the substrate, wherein the electrostatic lens diverges the beam of charged particles.

According to another embodiment of the present disclosure, there is provided a residue layer removing apparatus for removing a residue layer formed on a side surface of each of a plurality of convex-shaped structure which stands together on a surface of a substrate or a side surface of a concave-shaped structure formed on the substrate, including: a charged particle irradiation mechanism configured to linearly irradiate a beam of charged particles onto the substrate; and an electrostatic lens disposed between the substrate and the charged particle irradiation mechanism.

### BRIEF DESCRIPTION OF THE DRAWINGS

The accompanying drawings, which are incorporated in and constitute a part of the specification, illustrate embodiments of the present disclosure, and together with the general description given above and the detailed description of the embodiments given below, serve to explain the principles of the present disclosure.

FIG. 1 is a schematic sectional view illustrating the configuration of a trimming apparatus as a residue layer removing apparatus according to a first embodiment of the present disclosure.

FIG. 2 is a schematic sectional view illustrating the configuration of the GCIB irradiation device shown in FIG. 1.

FIGS. 3A to 3C are views for explaining a process in which a residue layer is formed on the side surface of a stack structure including a MTJ element.

FIG. 4 is a schematic perspective view illustrating the configuration of the electrostatic lens shown in FIG. 1.

FIG. 5 is a view for explaining a state of divergence of oxygen GCIB.

FIG. 6 is a view illustrating a simulation result of irradiation of oxygen GCIB by the electrostatic lens.

FIG. 7 is a view for explaining a residue layer removal method according to the first embodiment.

FIG. 8 is a view for explaining a range of irradiation of oxygen GCIB in a residue layer removal method according to the first embodiment.

FIG. 9 is a schematic sectional view illustrating the configuration of a trimming apparatus serving as a residue layer removing apparatus according to a second embodiment of the present disclosure.

FIG. 10 is a schematic perspective view illustrating the configuration of the electrostatic lens and the beam deflection electrode unit shown in FIG. 9.

FIGS. 11A and 11B are views for explaining changes in a path of oxygen GCIB.

FIG. 12 is a view illustrating a simulation result of oxygen GCIB irradiation by the beam deflection electrode unit.

FIGS. 13A to 13C are process views for explaining a conventional fabricating process of the MRAM having a MTJ element.

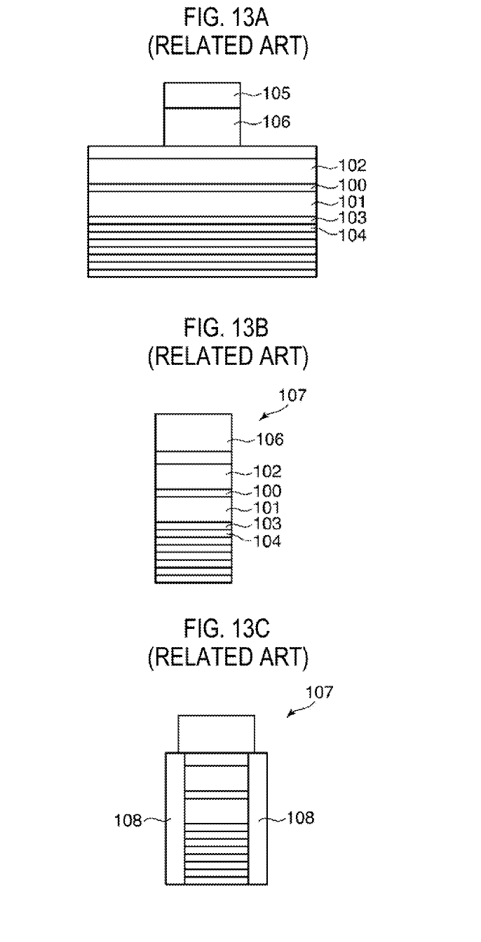

FIG. 14 is a view for explaining a method of irradiating oxygen GCIB on a surface of a tilted wafer in one direction.

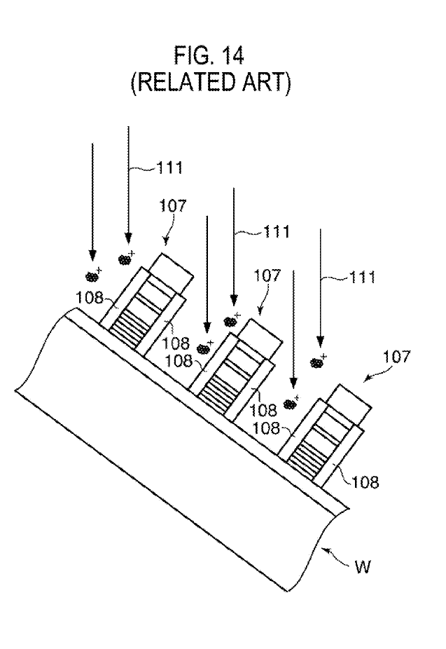

### DETAILED DESCRIPTION

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

First, a residue layer removing apparatus according to a first embodiment of the present disclosure will be described.

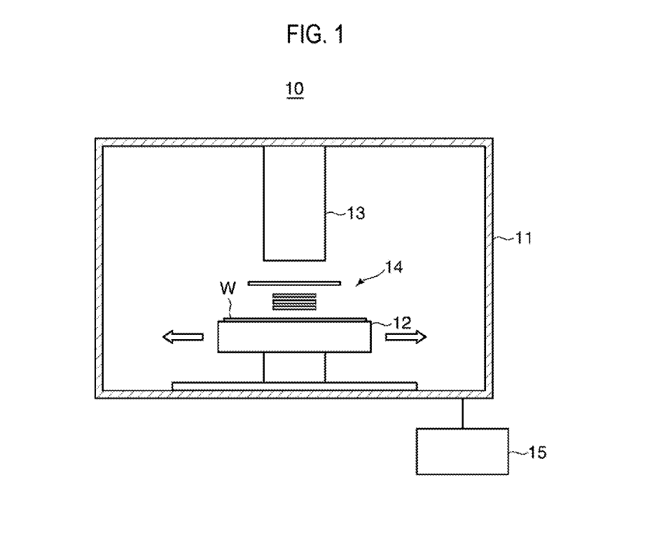

FIG. 1 is a schematic sectional view illustrating a trimming apparatus serving as a residue layer removing apparatus according to the first embodiment of the present disclosure.

As shown in FIG. 1, a trimming apparatus 10 includes a processing chamber 11 in which a wafer W is accommodated, a mounting table 12 disposed in the lower part of the processing chamber 11, a GCIB irradiation device (charged particle irradiation mechanism) 13 which is disposed in the upper part of the processing chamber 11 and substantially vertically irradiates a linear form of oxygen GCIB toward the wafer W mounted on the mounting table 12, an electrostatic lens 14 which is interposed between the GCIB irradiation device 13 and the mounting table 12, and a control unit 15 for controlling the operation of each component.

In the trimming apparatus 10, since the mounting table 12 is configured such that it can substantially horizontally move (see a white arrow in the figure) while facing the GCIB irradiation device 13, the relative position between the GCIB irradiation device 13 and the wafer W mounted on the mounting table 12 can be varied. Accordingly, a surface of the wafer W can be scanned (for example, raster-scanned) by the oxygen GCIB irradiated from the GCIB irradiation device 13. In addition, the mounting table 12 includes therein a refrigerant passage and a heater (both not shown) so that the mounted wafer W can be cooled or heated.

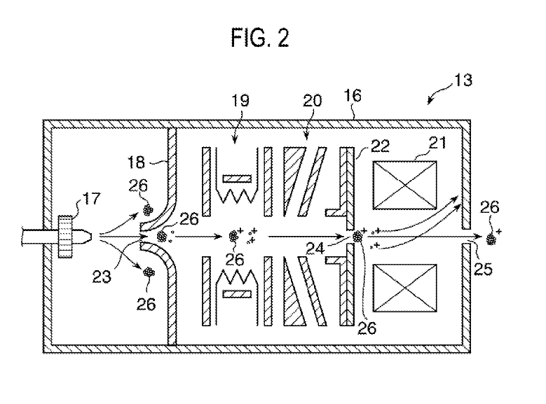

FIG. 2 is a schematic sectional view illustrating the configuration of the GCIB irradiation device shown in FIG. 1. Although the GCIB irradiation device 13 shown in FIG. 1 is substantially vertically disposed, for the convenience of description, it is depicted in FIG. 2 such that the device is substantially horizontally disposed.

As shown in FIG. 2, the GCIB irradiation device 13 includes a substantially vertically disposed tube-like main body 16 whose interior is depressurized, a nozzle 17 disposed at one end of the main body 16, a plate-like skimmer 18, an ionizer 19, an accelerator 20, a permanent magnet 21 and an aperture plate 22.

The nozzle 17 is disposed along the central axis of the main body 16 and ejects, e.g., an oxygen gas. The skimmer 18 is disposed to cover a cross section of the main body 16. The central portion of the skimmer 18 projects toward the nozzle 17 along the central axis of the main body 16 and a small hole 23 is formed in the apex of the projecting portion. The aperture plate 22 is also disposed to cover a cross section of the main body 16. The aperture plate 22 has an aperture hole 24 formed in a portion corresponding to the central axis of the main body 16. The other end of the main body 16 also has an aperture hole 25 formed in a portion corresponding to the central axis of the main body 16.

The ionizer 19, the accelerator 20 and the permanent magnet 21 are both disposed to surround the central axis of the main body 16. The ionizer 19 emits electrons toward the central axis of the main body 16 by heating an internal filament. The accelerator 20 generates a potential difference in the central axis of the main body 16. The permanent magnet 21 produces a magnetic field near the central axis of the main body 16.

In the GCIB irradiation device 13, the nozzle 17, the skimmer 18, the ionizer 19, the accelerator 20, the aperture plate 22 and the permanent magnet 21 are disposed in this order from the one end of the main body 16 (the left side in the figure) to the other end thereof (the right side in the figure).

When the nozzle 17 ejects an oxygen gas toward the depressurized interior of the main body 16, the volume of the oxygen gas is rapidly increased to cause a rapid adiabatic expansion and, accordingly, oxygen molecules are rapidly cooled. The rapidly cooled oxygen molecules are decreased in their kinetic energy and are brought into close contact with each other by an intermolecular force (Van Der Waals force) acting between the oxygen molecules, thereby forming a plurality of oxygen gas clusters 26, each of which consists of a number of oxygen molecules.

The skimmer 18 selects only the oxygen gas clusters 26 that move along the central axis of the main body 16, among the plurality of oxygen gas clusters 26 by means of the small hole 23. The ionizer 19 ionizes the oxygen gas clusters 26 moving along the central axis of the main body 16 to cations by causing electrons to collide with the oxygen gas clusters 26 to charge the oxygen gas clusters 26 with positive charges. The accelerator 20 accelerates the cationized oxygen gas clusters 26 toward the other end of the main body 16 by the potential difference. The aperture plate 22 only selects the oxygen gas clusters 26 that move along the central axis of the main body 16, among the accelerated oxygen gas clusters 26 by the aperture hole 24. The permanent magnet 21 changes a path of relatively small oxygen gas clusters 26 (including a monomer of cationized oxygen molecules) by the magnetic field. In the permanent magnet 21, relatively large oxygen gas clusters 26 are also affected by the magnetic field, but since the mass thereof is large, they continue to move along the central axis of the main body 16 with no change in path thereof by the magnetic field.

The relatively large oxygen gas clusters 26 which have passed through the permanent magnet 21 are emitted, as the oxygen GCIB, out of the main body 16 through the aperture hole 25 at the other end of the main body 16 and are bombarded onto the wafer W.

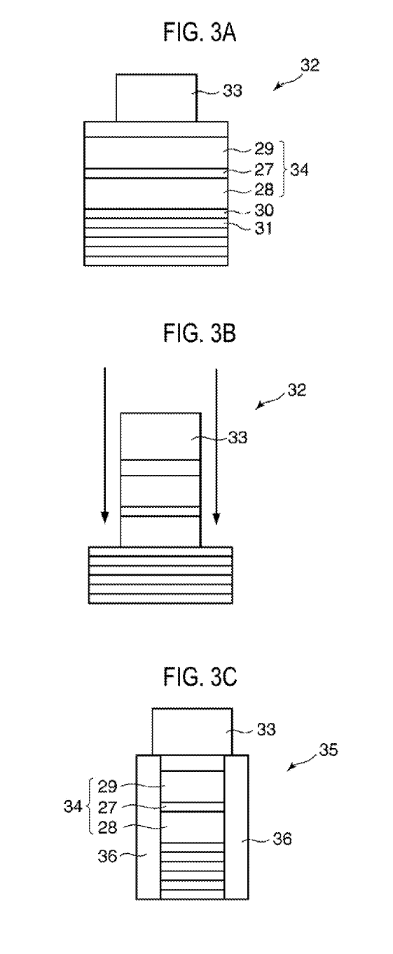

By the way, in a stack structure 32 including a MgO film 27, two opposing CoFeB films 28 and 29 with the MgO film 27 interposed therebetween, a Ta film 30 and a Ru film 31, all which are stacked on the wafer W as shown in FIG. 3A, the MRAM is fabricated by forming a pillar structure which is obtained by etching the films using a hard mask 33 formed on the stack structure 32. Further, the MgO film 27 and the CoFeB films 28 and 29 constitute MTJ element 34.

For example, when the stack structure 32 on the wafer W is subjected to a physical etching process, for example, plasma etching, by means of an etching apparatus, if sputtering by cations in plasma is made weak by setting a bias voltage applied to the wafer W to a non-high level, the hard mask 33 is not reduced even as time passes since the hard mask 33 is not cut by etching.

When the hard mask 33 is not reduced and thus the width of the hard mask 33 is not changed, a portion of each film in the stack structure 32 that is covered by the hard mask 33, is not cut by etching, whereas a portion of each film in the stack structure 32 that is not covered by the hard mask 33 continues to be cut by etching, thereby obtaining the pillar structure (see FIG. 3B). A number of pillar structures are formed on the surface of the wafer W and stand together substantially perpendicular to the surface.

At this time, however, metal (including noble metal) of each film in the stack structure 32 is sputtered and the scattered particulate metal is again attached to the side surface of the pillar structure 35 (convex-shaped structure), thereby forming a residue layer 36 on the side surface of the pillar structure 35. In addition, ions are implanted in the side surface (end portion of each film) of the stack structure 32 and a damage layer (including a bird's peak portion which is a magnetic characteristic change portion formed in both ends of the MgO film 27) (not shown) formed of an end portion of each film which lost its crystalline orientation due to the ion implantation is formed on the side surface of the pillar structure 35. Since the MgO film 27 and the CoFeB films 28 and 29 of the pillar structure 35 are electrically conductive due to the metal contained in the residue layer 36 and the damage layer and the magnetic characteristics of each film is changed due to the loss of the crystalline orientation, there is a possibility that the normal operation of the MRAM including a MTJ element 34 is disturbed.

The trimming apparatus 10 uses the oxygen GCIB in order to, especially, remove the residue layer 36 formed on the side surface of the pillar structure 35. More specifically, after the wafer W is loaded into the processing chamber 11 of the GCIB irradiation device 13 and mounted on the mounting table 12, an acetic acid gas is supplied into the processing chamber 11 and the oxygen GCIB is irradiated from the GCIB irradiation device 13 onto the wafer W.

At this time, in the pillar structure 35 of the wafer W on which the oxygen GCIB is irradiated, the cationized oxygen gas clusters 26 (charged particles) are collided with the residue layer 36 of the pillar structure 35. Thus, oxidation is accelerated in the residue layer 36 by kinetic energy of the oxygen gas clusters 26 and oxygen molecules decomposed from the oxygen gas clusters 26. As a result, an oxide of metal including noble metal such as Ta, Ru or the like which is an etching-resistive material existing in the residue layer 36 is generated. At this time, the noble metal oxide is sublimed by heat of the GCIB irradiation under high vapor pressure. Oxides of other metals such as Co or Fe are surrounded by a number of acetic acid molecules of the acetic acid gas. Since the metal oxides surrounded by a number of acetic acid molecules have a decreased intermolecular force or interatomic force acting between the metal oxides and other molecules or atoms, the metal oxides surrounded by a number of acetic acid molecules are sublimed by heat of the GCIB irradiation. As a result, the residue layer 36 is removed.

On the other hand, when the oxygen GCIB is irradiated from the GCIB irradiation device 13 substantially perpendicularly to the surface of the wafer W mounted on the mounting table 12, the oxygen GCIB is irradiated on each of the pillar structures, which stand together substantially perpendicular to the surface of the wafer W, along the height direction from the top portion. Further, the oxygen GCIB has high linearity as described previously. As a result, the oxygen GCIB is not completely irradiated on the residue layer 36 and, for example, since the hard mask 33 blocks the oxygen GCIB, a portion covered by the hard mask 33 remains.

In this embodiment, in response to this problem, the oxygen GCIB irradiated from the GCIB irradiation device 13 is diverged by the electrostatic lens 14.

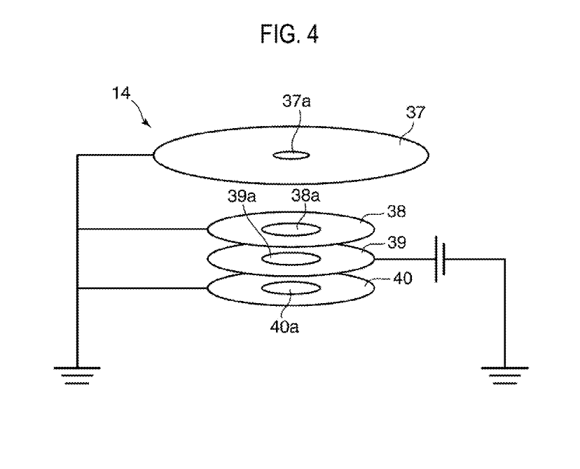

FIG. 4 is a schematic perspective view illustrating the configuration of the electrostatic lens shown in FIG. 1.

As shown in FIG. 4, the electrostatic lens 14 includes an aperture plate 37, a first electrode plate 38, a second electrode plate 39 and a third electrode plate 40, all which face toward each other and are disposed in this order from the GCIB irradiation device 13 side toward the mounting table 12. All of the aperture plate 37, the first electrode plate 38, the second electrode plate 39 and the third electrode plate 40 have a disc shape, with their centers aligned with the central axis of the GCIB irradiation device 13. These plates are disposed to be perpendicular to the central axis of the GCIB irradiation device 13. The aperture plate 37, the first electrode plate 38, the second electrode plate 39 and the third electrode plate 40 have in their respective centers an aperture hole 37a and passage holes 38a, 39a and 40a, respectively, through which the oxygen GCIB passes.

In addition, the aperture plate 37, the first electrode plate 38 and the third electrode plate 40 are grounded and the second electrode plate 39 is applied with a positive voltage (for example, +5 kV), so that a potential of the second electrode plate 39 is set to a positive potential. That is, in the electrostatic lens 14, since a potential of the third electrode plate 40 is set to be lower than the potential of the second electrode plate 39, an equipotential line 41 exhibiting a shape convex from the passage hole 39a toward the passage hole 40a is produced, and since a potential of the first electrode plate 38 is set to be lower than the potential of the second electrode plate 39, an equipotential line 42 exhibiting a shape convex from the passage hole 39a toward the passage hole 38a is produced.

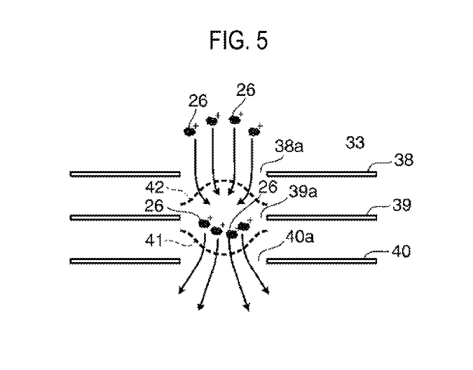

In addition, in the electrostatic lens 14, the cationized oxygen gas clusters 26 pass through the passage holes 38a, 39a and 40a of the first electrode plate 38, the second electrode plate 39 and the third electrode plate 40, as shown in FIG. 5, after passing through the aperture hole 37a of the aperture plate 37. The cationized oxygen gas clusters 26 moving from the passage hole 39a toward the passage hole 40a tend to move toward a lower potential and to try to pass the equipotential line 41 perpendicularly to the equipotential line 41.

In addition, since the potential of the first electrode plate 38 is set to be lower than the potential of the second electrode plate 39, the kinetic energy of the cationized oxygen gas clusters 26 moving from the passage hole 38a toward the passage hole 39a is converted into potential energy, so that a speed of the cationized oxygen gas clusters 26 is lowered. Thereafter, the speed-lowered cationized oxygen gas clusters 26 pass through the equipotential line 41. Thus, the cationized oxygen gas clusters 26 are affected by a potential difference for a longer period of time, and therefore, the cationized oxygen gas clusters 26 try to pass the equipotential line 41 more perpendicularly thereto.

As a result, since a path of each of the cationized oxygen gas clusters 26 is changed such that the oxygen GCIB is expanded toward the lower side in the figure, as a result of which the oxygen GCIB passing through the passage hole 40a is diverged.

In addition, in the electrostatic lens 14, since the cationized oxygen gas clusters 26 moving from the passage hole 38a toward the passage hole 39a try to pass the equipotential line 42 perpendicularly thereto, the path of each of the cationized oxygen gas clusters 26 is changed such that the oxygen GCIB is contracted toward the lower side in the figure, so that the oxygen GCIB passing through the passage hole 39a is contracted.

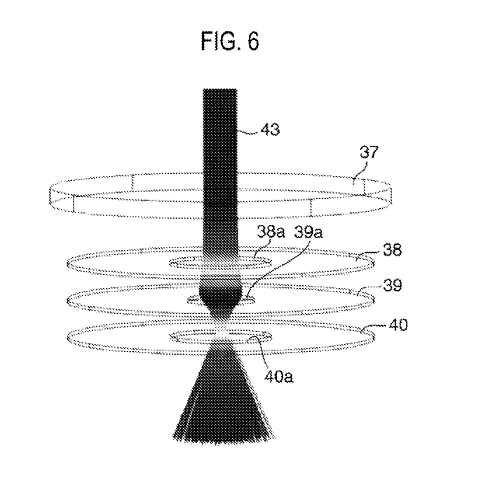

FIG. 6 is a view illustrating a simulation result of irradiation of the oxygen GCIB by the electrostatic lens.

As shown in FIG. 6, the oxygen GCIB 43 is contracted when passing through the passage hole 39a and is diverged when passing through the passage hole 40a.

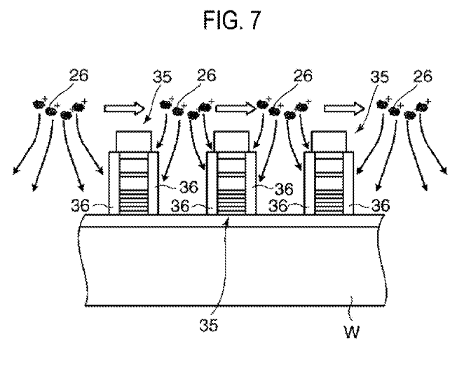

FIG. 7 is a view for explaining a residue layer removal method according to this embodiment.

First, after the wafer W is loaded into the processing chamber 11 of the GCIB irradiation device 13 and mounted on the mounting table 12, an acetic acid gas is supplied into the processing chamber 11 and the oxygen GCIB is irradiated from the GCIB irradiation device 13 onto the wafer W. At this time, by moving the mounting table 12 horizontally in one direction, the surface of the wafer W is raster-scanned by the oxygen GCIB irradiated from the GCIB irradiation device 13.

For example, when the mounting table 12 is moved to the left side in FIG. 1, since the GCIB irradiation device 13 relatively moves to the right side with respect to the mounting table 12, the surface of the wafer W is raster-scanned by the oxygen GCIB relatively moving to the right side as shown in FIG. 7. At this time, since the electrostatic lens 14 diverges the oxygen GCIB, the cationized oxygen gas clusters 26 moving obliquely to the irradiation direction of the oxygen GCIB (substantially the vertical direction) are generated. When the surface of the wafer W is raster-scanned by the oxygen GCIB, if one pillar structure 35 faces the oxygen GCIB, the cationized oxygen gas clusters 26, which are obliquely moving, contained in the oxygen GCIB collide with residue layers 36 on the side surfaces of other pillar structures 35 surrounding the one pillar structure 35. That is, as the oxygen GCIB moves, the cationized oxygen gas clusters 26 collide with the residue layer 36 on the side surface of each pillar structure 35. Accordingly, the oxygen GCIB can be irradiated onto the residue layer 36 on the side surface of each pillar structure 35 without tilting the wafer W, and thus, it is possible to eliminate the need to repeat a change in inclined angle of the wafer W. As a result, it is possible to increase efficiency for removing the residue layer 36 formed on the side surface of the pillar structure 35.

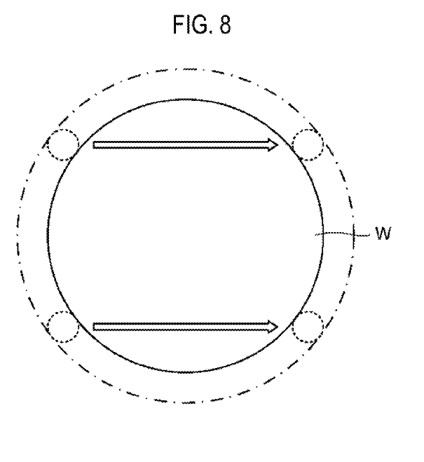

In addition, in the residue layer removal method according to this embodiment, a scanning range in which the oxygen GCIB is irradiated is wider than the surface of the wafer W. Specifically, as shown in FIG. 8, the scanning range (indicated by a dashed-dotted line in the figure) in which the oxygen GCIB is irradiated shows a circle and its diameter is equal to or larger than an addition of two diameters of the diverged oxygen GCIB (indicated by a broken line in the figure) and the diameter of the wafer W. Accordingly, the residue layer 36 formed on the side surface of the pillar structure 35 near the periphery of the wafer W can be reliably removed by the oxygen GCIB. In addition, in the residue layer removal method according to this embodiment, a raster scanning of the oxygen GCIB in one direction is performed in the scanning range of the oxygen GCIB as indicated by a white arrow in the figure.

Although the residue layer 36 is removed by the oxygen GCIB in the above-described residue layer removal method according to this embodiment, a damage layer may be also removed by the oxygen GCIB in addition to the residue layer 36. Further, if only a damage layer is formed on the side surface of the pillar structure 35, only the damage layer may be removed by the oxygen GCIB. In addition, the residue layer may contain Pt as well as Ta and Ru as noble metal.

In addition, in the above-described residue layer removal method according to this embodiment, although the oxygen GCIB is used and diverged, any ion beams may be employed as long as it includes charged particles. In addition, although the residue layer 36 of each pillar structure 35 is removed, the present disclosure may be applied to removal of a deposition layer or a damage layer deposited or formed on the side surface or bottom surface of a concave structure formed on a substrate, e.g. a trench or a via hole. In describing the present disclosure, the term “residue layer” may be used to refer to only a deposition layer deposited on side surfaces of a convex structure or a concave structure formed on a substrate, or only a damage layer formed on side surfaces of the convex structure or the concave structure. Further, it may refer to both the deposition layer and the damage layer.

In the above-described trimming apparatus 10, it is preferable in some embodiments that a distance between the electrostatic lens 14 and the wafer W mounted on the mounting table 12 is not too large. For example, the distance between the third electrode plate 40 of the electrostatic lens 14 and the wafer W may be 3 cm to 4 cm in some embodiments. This can prevent an increase of the divergence range of the oxygen GCIB on the surface of the wafer W and prevent a decrease in efficiency for removing the residue layer 36 due to a decrease in the density of the oxygen gas clusters 26 in the oxygen GCIB.

In addition, although the mounting table 12 is configured to be horizontally moved in the above-described trimming apparatus 10, it may be possible that the GCIB irradiation device 13 or the electrostatic lens 14 is horizontally moved instead of the movable mounting table.

In addition, in the above-described trimming apparatus 10, although the potentials of the first electrode plate 38 and the third electrode plate 40 are the ground potential while the potential of the second electrode plate 39 is set to a positive potential, the potentials of the first electrode plate 38, the second electrode plate 39 and the third electrode plate 40 are not limited thereto. For example, as long as the potentials of the first electrode plate 38 and the third electrode plate 40 are set to be lower than the potential of the second electrode plate 39, the potential of the first electrode plate 38 and the third electrode plate 40 may not be the ground potential. In addition, since the curvatures of the equipotential lines 41 and 42 vary depending on a potential difference between the second electrode plate 39 and the third electrode plate 40 or a potential difference between the first electrode plate 38 and the second electrode plate 39, it is possible to change a degree of divergence of the oxygen GCIB passing through the passage hole 40a or a degree of contraction of the oxygen GCIB passing through the passage hole 39a by adjusting the potential difference between the second electrode plate 39 and the third electrode plate 40 or the potential difference between the first electrode plate 38 and the second electrode plate 39.

In addition, in the above-described trimming apparatus 10, although the electrostatic lens 14 includes the first electrode plate 38, the second electrode plate 39 and the third electrode plate 40, the electrostatic lens 14 may be constituted by only the second electrode plate 39 and the third electrode plate 40 since only the equipotential line 41 exhibiting a shape convex from the passage hole 39a toward the passage hole 40a is necessary in order to diverge the oxygen GCIB.

Next, a residue layer removing apparatus according to a second embodiment of the present disclosure will be described.

The second embodiment has basically the same configuration and operation as those of the first embodiment except that a plurality of additional electrode plates is interposed between the electrostatic lens 14 and the mounting table 12. Therefore, the description of the same configuration and operation will be omitted and different configuration and operation will be explained in the following description.

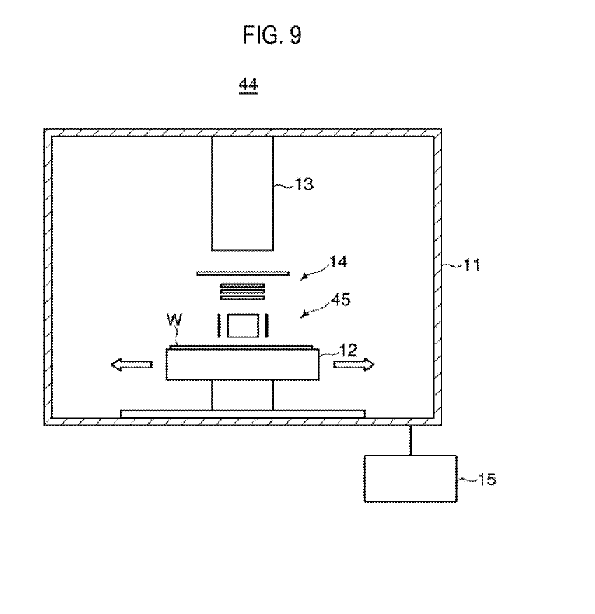

FIG. 9 is a schematic sectional view illustrating the configuration of a trimming apparatus as a residue layer removing apparatus according to the second embodiment.

As shown in FIG. 9, the trimming apparatus 44 further includes a beam deflection electrode unit 45 interposed between the electrostatic lens 14 and the mounting table 12.

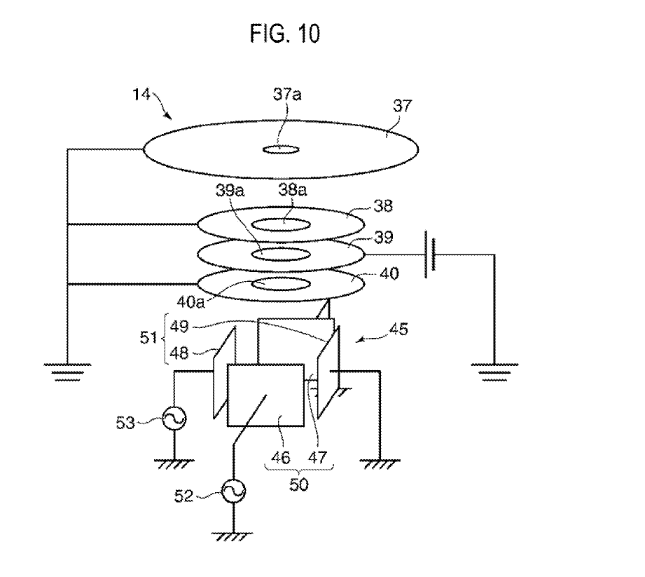

FIG. 10 is a schematic perspective view illustrating the configuration of the electrostatic lens and the beam deflection electrode unit shown in FIG. 9.

As shown in FIG. 10, the beam deflection electrode unit 45 includes four rectangular electrode plates 46, 47, 48 and 49 disposed to surround the oxygen GCIB passing through the electrostatic lens 14. The four rectangular electrode plates 46, 47, 48 and 49 are disposed at 90° pitches when viewed from the plane. The electrode plates 46 and 47 face with each other to form a first electrode pair 50 and the electrode plates 48 and 49 face with each other to form a second electrode pair 51.

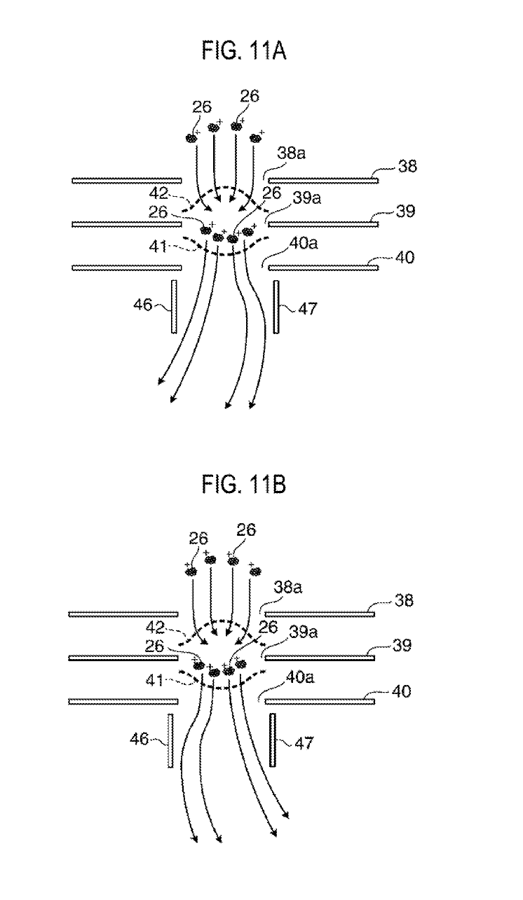

In the first electrode pair 50, the electrode plate 46 is grounded via a first high frequency power supply 52 and the electrode plate 47 is directly grounded. In the second electrode pair 51, the electrode plate 48 is grounded via a second high frequency power supply 53 and the electrode plate 49 is directly grounded. Thus, potentials of the electrode plate 46 and the electrode plate 47 periodically vary and potentials of the electrode plate 48 and the electrode plate 49 also periodically vary. Here, for example, in the first electrode pair 50, if the potential of the electrode plate 46 is lower than the potential of the electrode plate 47, the cationized oxygen gas clusters 26 in the oxygen GCIB are attracted to the electrode plate 46 by an electrostatic force from an electric field generated between the electrode plate 46 and the electrode plate 47. As a result, the oxygen GCIB is changed in its path and is irradiated obliquely with respect to the wafer W, i.e., downwardly and toward the left side in the figure (see FIG. 11A). In addition, in the case where the potential of the electrode plate 46 is higher than the potential of the electrode plate 47, the cationized oxygen gas clusters 26 in the oxygen GCIB are attracted to the electrode plate 47 by an electrostatic force. As a result, the oxygen GCIB is changed in its path and is irradiated obliquely to the wafer W (see FIG. 11B). In case of FIG. 11B, since the cationized oxygen gas clusters 26 receives an electrostatic force in the opposite direction to an electrostatic force received from the electric field in case of FIG. 11A, the oxygen GCIB is irradiated obliquely, i.e., downwardly and toward the right side in the figure.

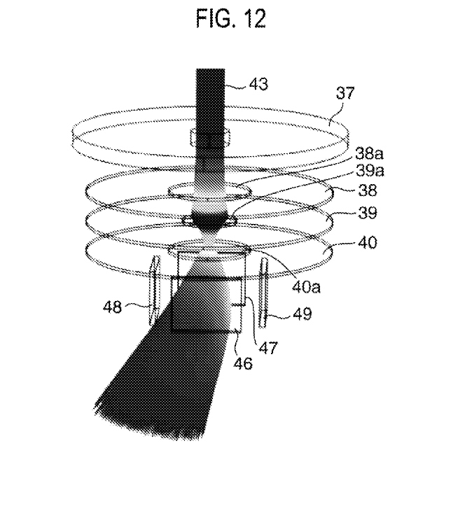

FIG. 12 is a view illustrating a simulation result of irradiation of the oxygen GCIB by the beam deflection electrode unit.

As shown in FIG. 12, the oxygen GCIB 43 is attracted in one direction, for example, a direction toward the electrode plate 46, when it passes through the beam deflection electrode unit 45. Thus, the oxygen GCIB 43 is irradiated obliquely downwardly from the beam deflection electrode unit 45.

In addition, in the second embodiment, a change period of the potentials of the electrode plate 46 and the electrode plate 47 is synchronized with a change period of the potentials of the electrode plate 48 and the electrode plate 49. Thus, for example, when the potentials of the electrode plate 46 and the electrode plate 47 vary according to a sine wave of a predetermined frequency, e.g., several 10 Hz, the potentials of the electrode plate 48 and the electrode plate 49 vary in a cosine wave of the same frequency. Thus, an electrostatic force to attract the oxygen GCIB to the electrode plate 46, an electrostatic force to attract the oxygen GCIB to the electrode plate 48, an electrostatic force to attract the oxygen GCIB to the electrode plate 47 and an electrostatic force to attract the oxygen GCIB to the electrode plate 49 are sequentially applied in this order on the oxygen GCIB passing through the beam deflection electrode unit 45. Accordingly, the oxygen GCIB which has passed through the beam deflection electrode unit 45 diverges and periodically revolves with respect to the surface of the wafer W. That is, a number of the oxygen gas clusters 26, which are obliquely moving, are included in the oxygen GCIB. As a result, when the surface of the wafer W is raster-scanned by the oxygen GCIB, it is possible to collide a number of the oxygen gas clusters 26 on the residue layer 36 on the side surface of each pillar structure 35 and thus further increase efficiency for removing the residue layer 36.

In addition, in the second embodiment, a damage layer may be also removed by the oxygen GCIB in addition to the residue layer 36. Alternatively, if only a damage layer is formed on the side surface of the pillar structure 35, only the damage layer may be removed by the oxygen GCIB.

Although the present disclosure has been described with the above embodiments, the present disclosure is not limited to the above embodiments.

The present disclosure can be implemented by providing a computer, e.g., the control unit 15, with a storage medium in which program codes of software for implementing the functions of the above embodiments and by causing a CPU of the control unit 15 to read and execute the program codes stored in the storage medium.

In this case, the program codes themselves read from the storage medium implement the functions of the above embodiments and thus, the program codes and the storage medium storing the program codes constitute the present disclosure.

Examples of the storage medium for providing the program codes may include RAM, NVRAM, Floppy disk (registered trademark), hard disk, opto-magnetic disk, optical disk such as CD-ROM, CD-R, CD-RW, DVD (DVD-ROM, DVD-RAM, DVD-RW, DVD+RW) or the like, magnetic tape, nonvolatile memory card, other ROMs or the like, all which can store the program codes. The program codes may be supplied to the control unit 15 by downloading from other computers or databases (not shown) connected to Internet, commercial network, local area network or the like.

In addition to implementing the functions of the above embodiments by allowing the control unit 15 to execute the read program codes, it is possible that an operating system (OS) or the like operated in CPU performs some or all of actual processes to implement the functions of the above embodiments, based on instructions of the program codes.

In addition, after the program codes read from the storage medium are transferred to a memory equipped in a function extension board inserted in the control unit 15 or a function extension unit connected to the control unit 15, CPU provided in the function extension board or the function extension unit may perform some or all of actual processes based on instructions of the program codes to implement the functions of the above embodiments.

The program codes may be in the form of object codes, program codes executed by an interpreter, script data supplied to OS, or the like.

According to the present disclosure in some embodiments, since the beam of charged particles is diverged by the electrostatic lens, charged particles moving obliquely to the irradiation direction of the beam of charged particles are generated. When one convex structure is faced with the beam of charged particles, the obliquely moving charged particles included in the beam of charged particles collide with the residue layer on the side surface of each of other convex structures surrounding the one convex structure. Accordingly, without tilting the substrate, the beam of charged particles can be irradiated onto the residue layer on the side surface of each convex structure. Thus, a need to repeat change of the inclined angle of the substrate can be eliminated. As a result, it is possible to increase efficiency for removing the residue layer formed on the side surface of the convex structure.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A method of removing a residue layer formed on a side surface of each of a plurality of convex-shaped structure which stands together on a surface of a substrate or a side surface of a concave-shaped structure formed on the substrate, comprising:
disposing an electrostatic lens between the substrate and a charged particle irradiation mechanism which linearly irradiates a beam of charged particles onto the substrate,
wherein the electrostatic lens diverges the beam of charged particles.

2. The method of claim 1, wherein the surface of the substrate is scanned with the diverged beam of charged particles.

3. The method of claim 2, wherein a range in which the beam of charged particles scans is wider than the surface of the substrate.

4. The method of claim 1, wherein the electrostatic lens includes a first electrode, a second electrode and a third electrode which face with each other and are disposed in this order from the charged particle irradiation mechanism to the substrate and the beam of charged particles passes through holes formed in the first electrode, the second electrode and the third electrode, respectively,
wherein a potential of the first electrode is set to be lower than a potential of the second electrode, and
wherein a potential of the third electrode is set to be lower than the potential of the second electrode.

5. The method of claim 4, wherein the potentials of the first electrode and the third electrode are a ground potential and the potential of the second electrode is a positive potential.

6. The method of claim 1, wherein a plurality of electrodes is disposed to surround the beam of charged particles between the electrostatic lens and the substrate and the plurality of electrodes has potentials.

7. The method of claim 6, wherein the plurality of electrodes has periodically varying potentials.

8. The method of claim 1, wherein the charged particles are ionized oxygen gas clusters and the beam of charged particles is irradiated onto the surface of the substrate under an acetic acid atmosphere.

9. The method of claim 1, wherein the residue layer includes at least one of a deposition layer and a damage layer.

10. A residue layer removing apparatus for removing a residue layer formed on a side surface of each of a plurality of convex-shaped structure which stands together on a surface of a substrate or a side surface of a concave-shaped structure formed on the substrate, comprising:
a charged particle irradiation mechanism configured to linearly irradiate a beam of charged particles onto the substrate; and
an electrostatic lens disposed between the substrate and the charged particle irradiation mechanism.

11. The residue layer removing apparatus of claim 10, wherein the electrostatic lens includes a first electrode, a second electrode and a third electrode which face with each other and are disposed in this order from the charged particle irradiation mechanism to the substrate,
wherein the first electrode, the second electrode and the third electrode have respective holes through which the beam of charged particles passes,
wherein a potential of the first electrode is set to be lower than a potential of the second electrode, and
wherein a potential of the third electrode is set to be lower than the potential of the second electrode.

12. The residue layer removing apparatus of claim 11, wherein the potentials of the first electrode and the third electrode are a ground potential and the potential of the second electrode is a positive potential.

13. The residue layer removing apparatus of claim 11, further comprising:
a mounting table configured to mount the substrate thereon and to move while facing the charged particle irradiation mechanism.

14. The residue layer removing apparatus of claim 10, further comprising:
a plurality of electrodes disposed to surround the beam of charged particles between the electrostatic lens and the substrate,
wherein the plurality of electrodes has potentials.
